(19) United States
(12) Patent Application Publication
(10) Pub. No.: US 2025/0337134 A1
(43) Pub. Date: Oct. 30, 2025

(54) SECONDARY BATTERY

(71) Applicant: Samsung SDI Co., Ltd., Yongin-si (KR)

(72) Inventors: Du Seon PARK, Yongin-si (KR); Tae Yoon LEE, Yongin-si (KR); Su Hyeon KANG, Yongin-si (KR); Jin Mun KIM, Yongin-si (KR); Duck Hyun KIM, Yongin-si (KR); Woon Suk JANG, Yongin-si (KR)

(21) Appl. No.: 19/009,503

(22) Filed: Jan. 3, 2025

(30) Foreign Application Priority Data
Apr. 30, 2024 (KR) 10-2024-0057311

(51) Int. Cl. H01M 50/566; B60L 50/64; H01M 50/107; H01M 50/152; H01M 50/342; H01M 50/533; H01M 50/559; H01M 50/636

(52) U.S. Cl. CPC H01M 50/566; H01M 50/107; H01M 50/152; H01M 50/3425; H01M 50/533; H01M 50/559; H01M 50/636; B60L 50/64; H01M 2220/20

(57) ABSTRACT

A secondary battery includes: a cylindrical case; an electrode assembly in the case and comprising a first tab protruding in a first direction and a second tab protruding in a second direction opposite to the first direction and connected to the case; a current collector plate in the case and comprising a current collector plate body portion connected to the first tab and a current collector plate liquid injection portion on the current collector plate body portion; a cap plate sealing the case so that the electrode assembly and the current collector plate are isolated from an outside; a rivet terminal including a rivet body portion coupled to the cap plate and a rivet liquid injection portion coupled to the current collector plate liquid injection portion; and a sealing portion sealing the current collector plate liquid injection portion and the rivet liquid injection portion.

### CROSS-REFERENCE TO RELATED APPLICATION

The present application claims priority to and the benefit of Korean Patent Application No. 10-2024-0057311, filed on Apr. 30, 2024, in the Korean Intellectual Property Office, the entire disclosure of which is incorporated herein by reference.

### BACKGROUND

### 1. Field

Aspects of some embodiments of the present invention relate to a secondary battery.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Aspects of some embodiments include a beading-free cylindrical secondary battery that may ensure sealing while relatively reducing the number of components and may also include a liquid injection port on a positive electrode side rather than a negative electrode side.

These and other aspects and features of the present disclosure will be described in or will be apparent from the following description of embodiments of the present disclosure.

A secondary battery according to some embodiments of the present disclosure includes a cylindrical case, an electrode assembly accommodated in the case and including a first tab protruding in a first direction and a second tab protruding in a second direction opposite to the first direction and connected to the case, a current collector plate accommodated in the case and including a current collector plate body portion connected to the first tab and a current collector plate liquid injection portion provided on the current collector plate body portion, a cap plate sealing the case so that the electrode assembly and the current collector plate are isolated from a outside, a rivet terminal including a rivet body portion coupled to the cap plate and a rivet liquid injection portion coupled to the current collector plate liquid injection portion, and a sealing portion sealing the current collector plate liquid injection portion and the rivet liquid injection portion.

According to some embodiments, the current collector plate liquid injection portion may protrude from a center of the current collector plate body portion in the first direction and may include a current collector plate liquid injection through-hole.

According to some embodiments, the rivet body portion may include an upper flange portion extending horizontally outward from an upper side of the rivet liquid injection portion and located on an upper side of the cap plate with an upper insulator interposed therebetween, and a lower flange portion extending horizontally outward from a lower side of the rivet liquid injection portion and located on a lower side of the cap plate with a lower insulator interposed therebetween, and the rivet liquid injection portion may be coupled through the cap plate with an insulating gasket interposed therebetween and may include a rivet liquid injection through-hole coupled to the current collector plate liquid injection portion.

According to some embodiments, an outer diameter surface of the current collector plate liquid injection portion and an inner diameter surface of the rivet liquid injection portion may contact each other and may be provided parallel to the first direction.

According to some embodiments, the outer diameter surface of the current collector plate liquid injection portion and the inner diameter surface of the rivet liquid injection portion may contact each other and may be provided to be inclined with respect to the first direction.

According to some embodiments, an outer diameter of the current collector plate liquid injection portion and an inner diameter of the rivet liquid injection portion may gradually decrease as a distance from the electrode assembly increases.

According to some embodiments, an upper side of the current collector plate liquid injection portion and an upper side of the rivet liquid injection portion may be coupled by laser welding.

According to some embodiments, the sealing portion may include a sealing body portion covering the current collector plate liquid injection portion and the rivet liquid injection portion and a sealing protrusion coupled to the current collector plate liquid injection portion.

According to some embodiments, the rivet liquid injection portion may include a rivet recess on which the sealing body portion is seated.

According to some embodiments, a circumference of the sealing body portion may be coupled to the rivet recess by laser welding.

According to some embodiments, the secondary battery may further include a sealing ball coupled to the current collector plate liquid injection portion, and the sealing portion may include a sealing body portion covering the current collector plate liquid injection portion and the rivet liquid injection portion.

According to some embodiments, the rivet liquid injection portion may include a rivet recess on which the sealing body portion is seated.

According to some embodiments, a circumference of the sealing body portion may be coupled to the rivet recess by laser welding.

According to some embodiments, the case may include a bottom portion and a side wall portion extending in the first direction from a circumference of the bottom portion, and the second tab may be coupled to the bottom portion by laser welding.

According to some embodiments, the bottom portion may include a circumferential portion adjacent to the side wall portion, a vent notch provided in the circumferential portion, and a recessed portion extending inward from the circumferential portion and located closer to the electrode assembly than the circumferential portion.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIGS. 1A and 1B are perspective and cross-sectional views showing aspects of an example cylindrical secondary battery according to some embodiments.

FIGS. 2A and 2B are enlarged cross-sectional views showing areas 2a and 2b of FIG. 1B.

FIGS. 3A and 3B are an exploded cross-sectional perspective view and an assembled cross-sectional perspective view showing aspects of an example cylindrical secondary battery according to some embodiments.

FIG. 4 is a cross-sectional perspective view showing aspects of an example case of the cylindrical secondary battery according to some embodiments.

FIGS. 5A and 5B are enlarged cross-sectional perspective views showing areas 5a and 5b of FIG. 4.

FIG. 6 is a cross-sectional perspective view showing aspects of an example cap assembly and aspects of an example current collector plate of the cylindrical secondary battery according to some embodiments.

FIGS. 7A and 7B are enlarged cross-sectional views showing a positive electrode sealing structure of the cylindrical secondary battery according to some embodiments.

FIG. 8 is an enlarged cross-sectional view showing another positive electrode sealing structure of the cylindrical secondary battery according to some embodiments.

FIGS. 9A and 9B are perspective and cross-sectional views showing a sealing portion forming the positive electrode sealing structure of the cylindrical secondary battery according to some embodiments.

FIG. 10 is a cross-sectional view showing the sealing portion forming the positive electrode sealing structure of the cylindrical secondary battery according to some embodiments.

FIGS. 11A and 11B are perspective views showing a battery pack including the cylindrical secondary battery according to some embodiments.

FIGS. 12A and 12B are perspective and side views showing a vehicle including aspects of an example battery pack according to some embodiments.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be arranged in contact with the upper (or lower) surface of the element, and another element may also be interposed between the element and the arbitrary element located on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in this specification are for describing embodiments of the present disclosure and are not intended to limit the present disclosure.

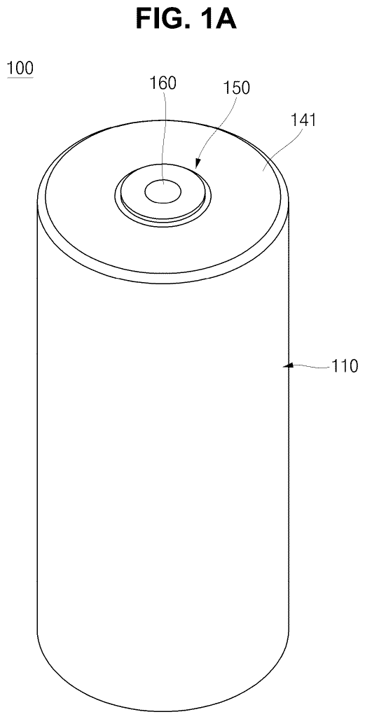

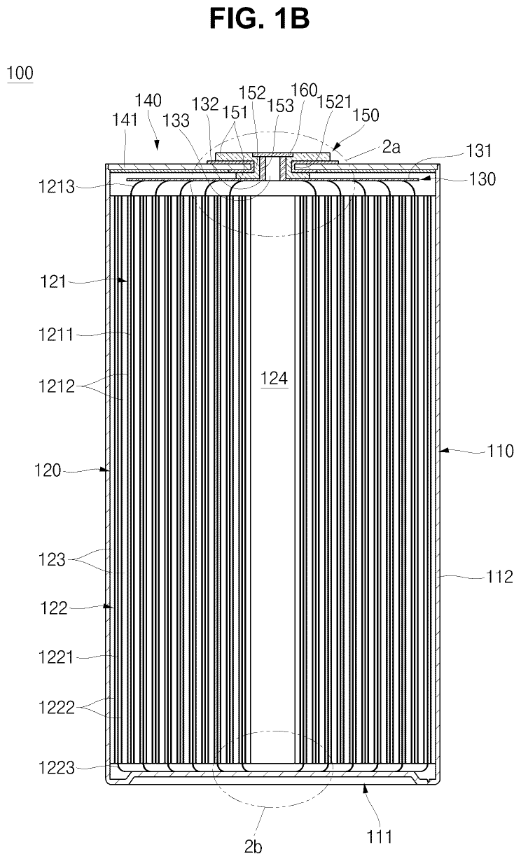

FIGS. 1A and 1B are perspective and cross-sectional views showing aspects of an example cylindrical secondary battery 100 according to some embodiments. As shown in FIGS. 1A and 1B, the secondary battery 100 according to some embodiments may include a case 110, an electrode assembly 120, a current collector plate 130, a cap plate 141, a rivet terminal 150, and a sealing portion 160.

The case 110 may accommodate the electrode assembly 120 and an electrolyte and form the exterior of the secondary battery 100 along with the cap plate 141. The case 110 may include a disk-shaped (or substantially disk-shaped) bottom portion 111 and a cylindrical side wall portion 112 extending upward from the bottom portion 111. According to some embodiments, the case 110 may be formed in various shapes, such as a pouch shape in addition to a circular shape. In addition, the case 110 may include a metal such as steel, nickel-plated steel, a steel alloy, aluminum, an aluminum alloy, or a cold rolled sheet for deep drawing (SPCE), or a laminated film or plastic that forms a pouch.

The electrode assembly 120 may include a first electrode plate 121, a second electrode plate 122, and a separator 123 between the first electrode plate 121 and the second electrode plate 122, and may be wound in a jelly-roll form. According to some embodiments, a hollow core 124 may be provided in the center of the electrode assembly 120 in a longitudinal direction. According to some embodiments, a center pin (optional) may be coupled to the core 124.

The first electrode plate 121 may include a first substrate 1211 and a first active material layer 1212 located on the first substrate 1211. A first uncoated portion or first tab 1213 where the first active material layer 1212 is not located on the first substrate 1211 may extend outward (for example, upward) and the first tab 1213 may be electrically connected to the cap plate 141.

The second electrode plate 122 may include a second substrate 1221 and a second active material layer 1222 located on the second substrate 1221. A second uncoated portion or second tab 1223 where the second active material layer 1222 is not located on the second substrate 1221, may extend outward (for example, downward) and the second tab 1223 may be electrically connected to the case 110. According to some embodiments, the first tab 1213 and the second tab 1223 may extend in opposite directions.

The first electrode plate 121 may function as a positive electrode. In this case, the first substrate 1211 may be made of, for example, an aluminum foil, and the first active material layer 1212 may include, for example, a transition metal oxide. The second electrode plate 122 may function as a negative electrode. In this case, the second substrate 1221 may be made of, for example, a copper foil or a nickel foil, and the second active material layer 1222 may include, for example, graphite and/or silicon.

The separator 123 may allow the movement of lithium ions while preventing or reducing instances of a short circuit between the first electrode plate 121 and the second electrode plate 122. According to some embodiments, the separator 123 may be located on opposite sides of the first electrode plate 121 or on opposite sides of the second electrode plate 122.

As the positive electrode active material, a compound capable of reversibly intercalating/deintercalating lithium (e.g., a lithiated intercalation compound) may be used. For example, at least one of a composite oxide of lithium and/or a metal selected from cobalt, manganese, nickel, and/or combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOx (0<x<2), a Si-based alloy, or a combination thereof.

The silicon-carbon composite may be a composite of silicon and amorphous carbon. According to some embodiments, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer located on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based heavy antibody or a (meth)acrylic polymer.

The inorganic material may include inorganic particles selected from Al2O3, SiO2, TiO2, SnO2, CeO2, MgO, NiO, CaO, GaO, ZnO, ZrO2, Y2O3, SrTiO3, BaTiO3, Mg(OH)2, boehmite, and combinations thereof but is not limited thereto.

The organic material and the inorganic material may be mixed in one coating layer or may be in the form of a coating layer containing an organic material and a coating layer containing an inorganic material that are laminated on each other.

The current collector plate 130 may include a current collector plate body portion 131 and a current collector plate liquid injection portion 132. According to some embodiments, the current collector plate liquid injection portion 132 may further include a current collector plate liquid injection through-hole 133. The current collector plate body portion 131 may have a round disk shape (or substantially round disk shape), and a plurality of first tabs 1213 extending/protruding from the electrode assembly 120 may be electrically connected to the lower surface of the current collector plate body portion 131. The current collector plate liquid injection portion 132 may be electrically/mechanically coupled to the rivet terminal 150. According to some embodiments, the electrolyte may be injected through the current collector plate liquid injection through-hole 133. Therefore, the electrolyte may be directly provided to the core 124 of the electrode assembly 120, and then the electrolyte may be absorbed into the remaining area of the electrode assembly 120. The current collector plate 130 may include, for example, aluminum, an aluminum alloy, copper, a copper alloy, nickel, or a nickel alloy.

The cap plate 141 may be coupled to an upper side of the case 110 to seal the case 110. The cap plate 141 may be provided in a substantially disk shape. According to some embodiments, the circumference of the cap plate 141 may be coupled to the side wall portion 112 of the case 110 to seal the case 110. The cap plate 141 may be made of iron, nickel-plated iron, stainless steel, aluminum, or an aluminum alloy. According to some embodiments, the cap plate 141 and the rivet terminal 150 coupled with an insulating member interposed therebetween are collectively referred to as a cap assembly 140. In other words, depending on the case, the cap assembly 140 may be a concept that includes a cap plate and a rivet terminal.

The rivet terminal 150 may include a rivet body portion 151 and a rivet liquid injection portion 152. According to some embodiments, the rivet liquid injection portion 152 may include a rivet liquid injection through-hole 153. The rivet liquid injection portion 152 may be coupled through the cap plate 141. An insulating gasket 1521 may be interposed between the rivet liquid injection portion 152 and the cap plate 141. The rivet terminal 150 may be electrically/mechanically coupled to the current collector plate 130. According to some embodiments, the current collector plate liquid injection portion 132 may be fitted into the rivet liquid injection portion 152. In other words, the current collector plate liquid injection portion 132 may be coupled to the rivet liquid injection through-hole 153. The rivet terminal 150 may include aluminum, an aluminum alloy, copper, a copper alloy, nickel, or a nickel alloy.

The sealing portion 160 may be coupled to the rivet terminal 150. The sealing portion 160 may be provided in a substantially disk shape. The sealing portion 160 may plug the current collector plate liquid injection portion 132 and the rivet liquid injection portion 152. In other words, the sealing portion 160 may plug the current collector plate liquid injection through-hole 133. The sealing portion 160 may include aluminum, an aluminum alloy, copper, a copper alloy, nickel, or a nickel alloy.

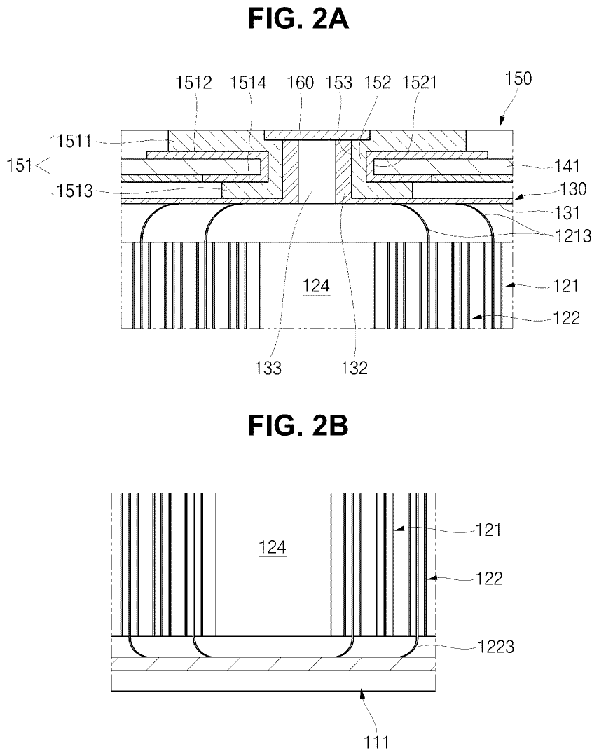

FIGS. 2A and 2B are enlarged cross-sectional views showing further details of the areas 2a and 2b of FIG. 1B.

As shown in FIG. 2A, the current collector plate 130 may include the current collector plate body portion 131 connected (e.g., laser welded) to the first tab 1213 and the current collector plate liquid injection portion 132 extending upward from the current collector plate body portion 131, and the current collector plate liquid injection portion 132 may include the current collector plate liquid injection through-hole 133. According to some embodiments, since a compaction process is performed on the first tab 1213 in one direction (e.g., a direction toward or away from the core), the first tab 1213 may be connected to the current collector plate body portion 131 while lying horizontal in one direction. In addition, the rivet terminal 150 may include the rivet body portion 151 coupled to the cap plate 141 and the rivet liquid injection portion 152 coupled to the current collector plate liquid injection portion 132, and the rivet liquid injection portion 152 may include the rivet liquid injection through-hole 153. In addition, the sealing portion 160 may be coupled (e.g., laser welded) to the current collector plate liquid injection portion 132 and the rivet liquid injection portion 152.

According to some embodiments, the current collector plate liquid injection portion 132 may protrude in a first direction from the center of the current collector plate body portion 131 and include the current collector plate liquid injection through-hole 133 provided in the inner center.

According to some embodiments, the rivet body portion 151 may include an upper flange portion 1511 bent and extending in an outward horizontal direction from an upper side of the rivet liquid injection portion 152 and located on an upper side of the cap plate 141. According to some embodiments, an upper insulator 1512 may be interposed between the upper flange portion 1511 and the cap plate 141.

According to some embodiments, the rivet body portion 151 may also include a lower flange portion 1513 bent and extending in an outward horizontal direction from a lower side of the rivet liquid injection portion 152 and located on a lower side of the cap plate 141. According to some embodiments, a lower insulator 1514 may be interposed between the lower flange portion 1513 and the cap plate 141.

According to some embodiments, the rivet liquid injection portion 152 may be coupled through the cap plate 141 with the insulating gasket 1521 interposed therebetween. As described above, the current collector plate liquid injection portion 132 may be coupled to the rivet liquid injection through-hole 153. According to some embodiments, the upper insulator 1512, the insulating gasket 1521, and the lower insulator 1514 may be formed integrally or formed separately and then integrated.

As shown in FIG. 2B, the bottom portion 111 of the case 110 may be connected (e.g., laser welded) to the second tab 1223. According to some embodiments, since a compaction process is performed on the second tab 1223 in one direction (e.g., a direction toward or away from the core), the second tab 1223 may be connected to the bottom portion 111 of the case 110 while lying horizontal in one direction.

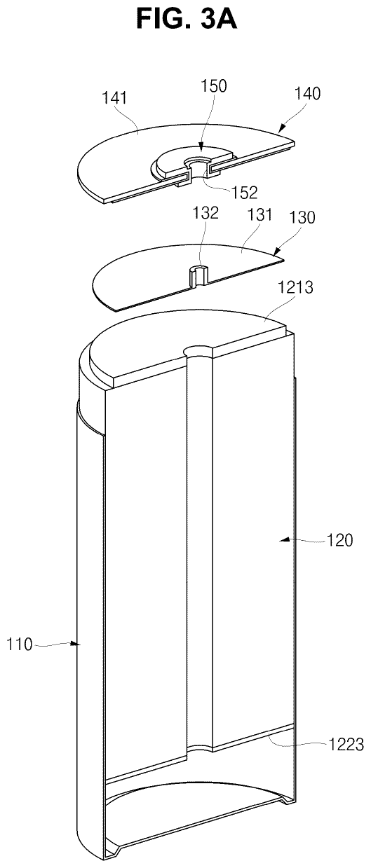

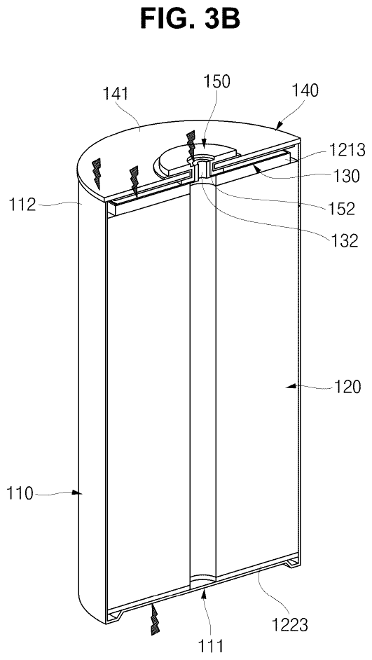

FIGS. 3A and 3B are an exploded cross-sectional perspective view and an assembled cross-sectional perspective view showing aspects of an example cylindrical secondary battery 100 according to some embodiments.

As shown in FIG. 3A, the cylindrical electrode assembly 120 may be coupled to the cylindrical case 110, and then the current collector plate 130 may be positioned on the electrode assembly 120, and finally, the cap assembly 140, which includes the cap plate 141 and the rivet terminal 150, may be coupled to the case 110.

As shown in FIG. 3B, the current collector plate liquid injection portion 132 and the rivet liquid injection portion 152 may be coupled to each other by laser welding. In addition, the circumference of the cap plate 141 and the side wall portion 112 of the case 110 may be coupled to each other by laser welding. In addition, the second tab 1223 of the electrode assembly 120 may be laser welded to the bottom portion 111 of the case 110. According to some embodiments, the first tab 1213 of the electrode assembly 120 may be laser welded first to the current collector plate body portion 131. The lightning bolt symbol in the drawing represents the laser welding.

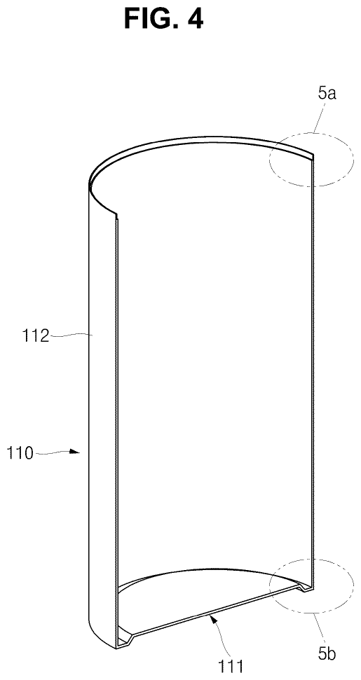

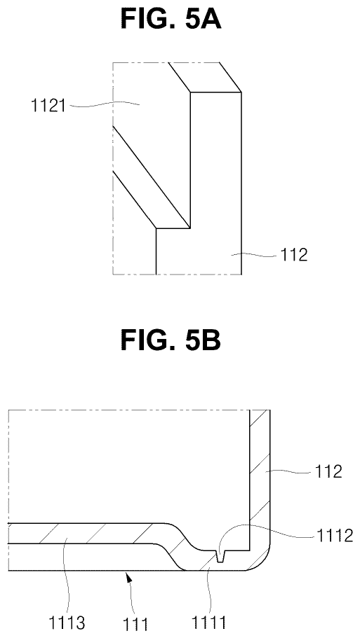

FIG. 4 is a cross-sectional perspective view showing aspects of an example case 110 in the cylindrical secondary battery 100 according to some embodiments, and FIGS. 5A and 5B are enlarged cross-sectional perspective views showing areas 5a and 5b of FIG. 4.

As shown in FIGS. 4, 5A, and 5B, the case 110 may include the bottom portion 111 and the side wall portion 112 extending in a first direction from the circumference of the bottom portion 111. According to some embodiments, the bottom portion 111 may include a circumferential portion 1111 adjacent to the side wall portion 112, a vent notch 1112 provided in the circumferential portion 1111, and a recessed portion 1113 extending inward from the circumferential portion 1111 and located closer to the electrode assembly 120 than the circumferential portion 1111. According to some embodiments, the vent notch 1112 may be provided on an upper side of the circumferential portion 1111. Thus, when the internal pressure of the secondary battery 100 rises, the recessed portion 1113 may first deform in a direction away from the electrode assembly 120 (e.g., in a second direction), and when the internal pressure of the battery exceeds a reference pressure, the vent notch 1112 may break, thereby allowing the internal gas of the battery to be discharged to the outside. According to some embodiments, the second tab 1223 of the electrode assembly 120 may be directly laser welded to the recessed portion 1113 of the bottom portion 111.

According to some embodiments, a groove 1121 may be further provided at an upper end of the side wall portion 112. According to some embodiments, the groove 1121 may be provided on an inner side of the side wall portion 112. Therefore, the cap plate 141 may be coupled to the groove 1121 of the side wall portion 112. Of course, the boundary area between the cap plate 141 and the side wall portion 112 may be coupled by laser welding.

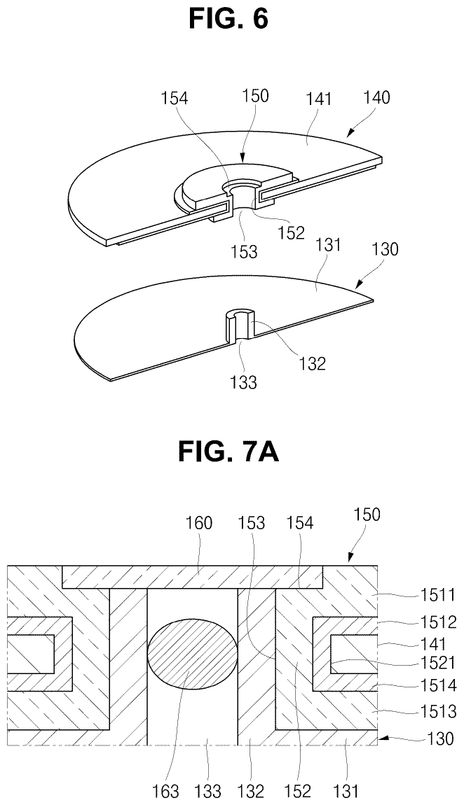

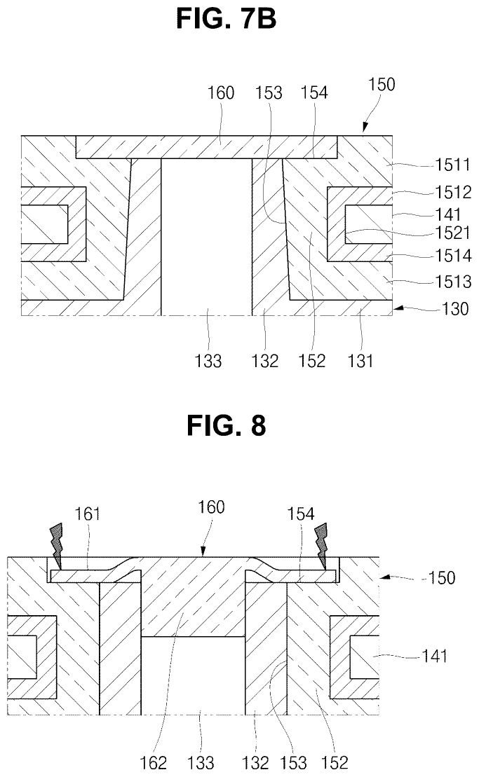

FIG. 6 is a cross-sectional perspective view showing aspects of an example cap assembly 140 and aspects of an example current collector plate 130 in the cylindrical secondary battery 100 according to some embodiments, and FIGS. 7A and 7B are enlarged cross-sectional views showing a positive electrode sealing structure in the cylindrical secondary battery 100 according to some embodiments.

As shown in FIGS. 6 and 7A, the current collector plate liquid injection portion 132 may be inserted into the rivet liquid injection portion 152. According to some embodiments, an upper end of the current collector plate liquid injection portion 132 may be substantially flush with an upper end of the rivet liquid injection portion 152. According to some embodiments, the upper end of the current collector plate liquid injection portion 132 may be substantially flush with an upper end of a rivet recess 154 of the rivet liquid injection portion 152. According to some embodiments, an outer diameter surface of the current collector plate liquid injection portion 132 and an inner diameter surface of the rivet liquid injection portion 152 may be in close contact with or in contact with each other, and the outer diameter surface of the current collector plate liquid injection portion 132 and the inner diameter surface of the rivet liquid injection portion 152 may be provided substantially parallel to the first direction.

Meanwhile, as shown in FIG. 7B, the outer diameter surface of the current collector plate liquid injection portion 132 and the inner diameter surface of the rivet liquid injection portion 152 may be in close contact with or in contact with each other, and the outer diameter surface of the current collector plate liquid injection portion 132 and the inner diameter surface of the rivet liquid injection portion 152 may be provided substantially inclined with respect to the first direction. According to some embodiments, an outer diameter of the current collector plate liquid injection portion 132 and an inner diameter of the rivet liquid injection portion 152 may gradually decrease as the distance from the electrode assembly 120 increases.

According to some embodiments, the upper side of the current collector plate liquid injection portion 132 and the upper side of the rivet liquid injection portion 152 may be coupled to each other by laser welding. According to some embodiments, a substantially plate-shaped sealing portion 160 may be seated on the rivet recess 154 of the rivet liquid injection portion 152. According to some embodiments, the circumference of the sealing portion 160 may be coupled to the rivet recess 154 by laser welding. According to some embodiments, the upper surface of the sealing portion 160 and the upper surface of the rivet terminal 150 (e.g., the upper surface of the upper flange portion 1511) may form the same surface.

According to some embodiments, a sealing ball 163 may be further coupled to the current collector plate liquid injection through-hole 133. According to some embodiments, the sealing ball 163 may include polypropylene resin, polyethylene resin, or a deformable metal ball. A sealing force for an electrolyte may be relatively improved by this sealing ball 163.

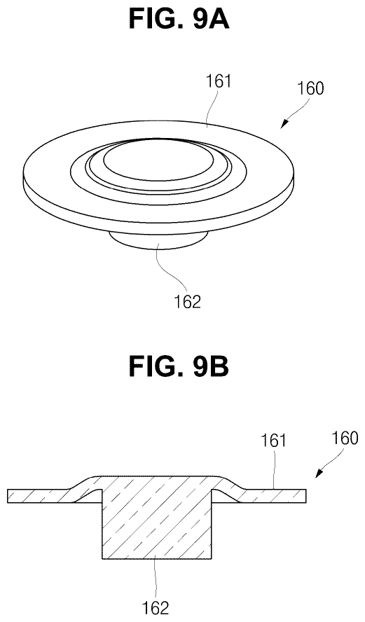

FIG. 8 is an enlarged cross-sectional view showing another positive electrode sealing structure in the cylindrical secondary battery 100 according to some embodiments, and FIGS. 9A and 9B are perspective and cross-sectional views showing the sealing portion 160 that forms the positive electrode sealing structure in the cylindrical secondary battery 100 according to some embodiments. In FIG. 8, the lightning bolt symbol represents laser welding.

As shown in FIGS. 8, 9A, and 9B, the sealing portion 160 may include a sealing body portion 161 that covers the current collector plate liquid injection portion 132 and the rivet liquid injection portion 152, and a sealing protrusion 162 that is coupled to the current collector plate liquid injection portion 132. According to some embodiments, the length of the sealing protrusion 162 may be similar to or shorter than the length of the current collector plate liquid injection portion 132. According to some embodiments, the sealing body portion 161 may be seated on the rivet liquid injection portion 152, and the circumference of the sealing body portion 161 may be seated on the rivet recess 154. According to some embodiments, the circumference of the sealing body portion 161 may be coupled to the rivet recess 154 by laser welding.

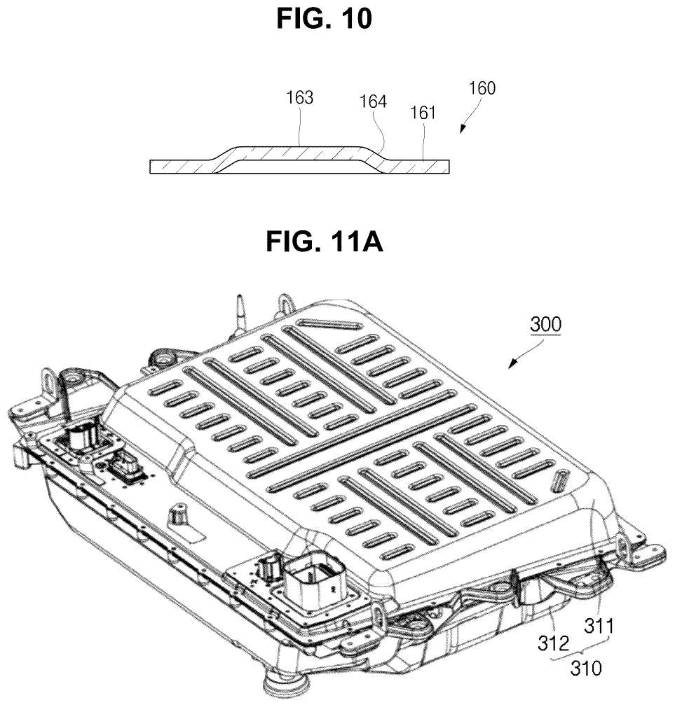

FIG. 10 is a cross-sectional view showing the sealing portion 160 forming a positive electrode sealing structure in the cylindrical secondary battery 100 according to some embodiments. As shown in FIG. 10, the sealing portion 160 may have a substantially flat plate shape without the sealing protrusion 162. According to some embodiments, the sealing portion 160 may include an upper flat portion 163 seated on the current collector plate liquid injection portion 132, a bent portion 164 bent downward from the upper flat portion 163, and a lower flat portion 165 seated on and laser welded to the rivet liquid injection portion 152 (i.e., the rivet recess 154).

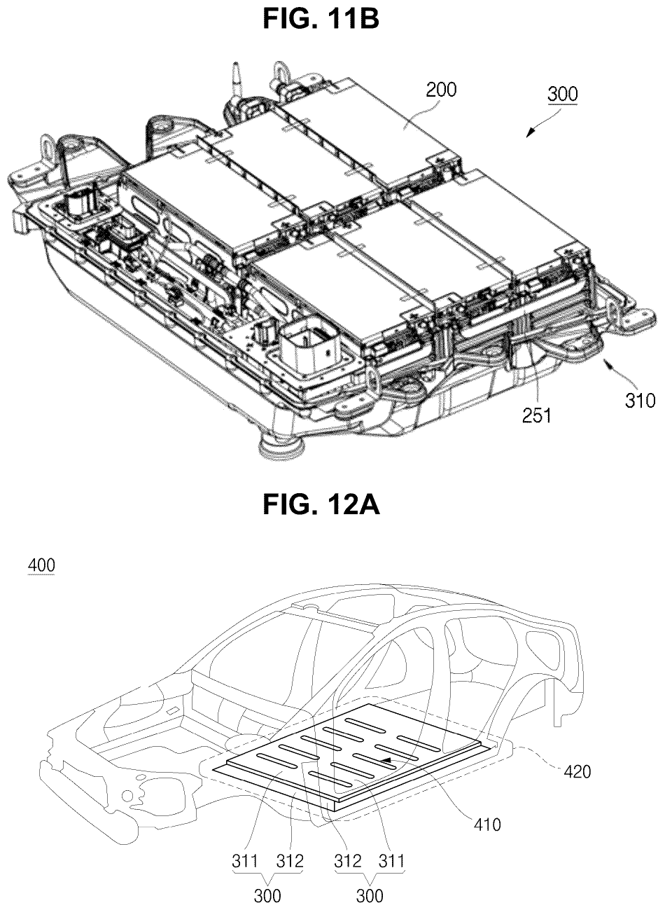

FIGS. 11A and 11B are perspective views showing a battery pack 300 including the cylindrical secondary battery according to some embodiments. Referring to FIGS. 11A and 11B, the battery pack 300 may include a plurality of battery modules 200 and a housing 310 for accommodating the plurality of battery modules 200. For example, the housing 310 may include first and second housings 311 and 312 coupled in opposite directions through the plurality of battery modules 200. The plurality of battery modules 200 may be electrically connected to each other by using a bus bar 251, and the plurality of battery modules 200 may be electrically connected to each other in a series/parallel or series-parallel mixed method, thereby obtaining desired (e.g., required) electrical output. In the FIGS. 5A and 5B, for convenience of illustration, parts such as bus bars, cooling units, and external terminals for electrical connection of battery cells are omitted. In one or more embodiments, battery pack 300 may be mounted in a vehicle. The vehicle may be, for example, an electric vehicle, a hybrid vehicle, or a plug-in hybrid vehicle. The vehicle may include a four-wheeled vehicle or a two-wheeled vehicle.

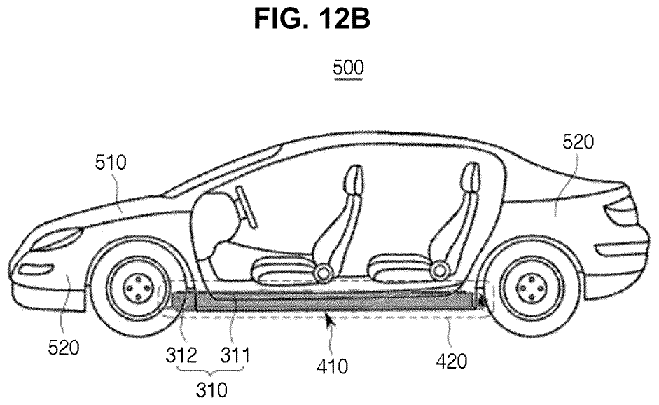

FIGS. 12A and 12B are perspective and side views showing vehicles 400 and 500 including the battery pack 300 according to some embodiments. In FIG. 12A, a battery pack 300 may include a battery pack cover 311 (may correspond to the first housing above), which is a part of a vehicle underbody 410, and a pack frame 312 (may correspond to the second housing above) located under the vehicle underbody 410. The pack frame 312 and the battery pack cover 311 may be integrally formed with a vehicle floor 420. The vehicle underbody 410 separates the inside and outside of a vehicle, and the pack frame 312 may be located outside the vehicle.

In FIG. 12B, a vehicle 500 may be formed by combining additional parts, such as a hood 510 in front of the vehicle and fenders 520 respectively located in the front and rear of the vehicle to a vehicle body parts 400. The vehicle 500 may further include a vehicle floor 420, which is one of the vehicle body parts 400 including the battery pack 300 including the pack frame 312 and the battery pack cover 311.

According to some embodiments, it may be possible to provide a beading-free cylindrical secondary battery that ensures sealing while reducing the number of components and is also provided with a liquid injection port on a positive electrode side rather than a negative electrode side. In addition, according to some embodiments, it may be possible to provide a secondary battery in which the welding strength of the positive electrode terminal can be relatively enhanced and welding defects can be relatively easily detected because the structure of the positive electrode terminal may be relatively improved. Additionally, according to some embodiments, it may be possible to provide a secondary battery in which sealing can be enhanced and welding defects can be relatively easily detected because a sealing pin is coupled and welded to the positive electrode liquid injection port.

However, aspects and features of the present disclosure are not limited to those described above, and other aspects and features not mentioned will be clearly understood by a person skilled in the art from the detailed description, described above

Although aspects of some embodiments of the present disclosure have been described above with limited examples and drawings, embodiments according to the present disclosure are not limited thereto, and various modifications and variations may be made by those skilled in the art in the technical field to which the present invention belongs within the technical idea of embodiments according to the present disclosure and the equivalent scope of the appended claims described below.

What is claimed is:

1. A secondary battery comprising:
a cylindrical case;
an electrode assembly in the case and comprising a first tab protruding in a first direction and a second tab protruding in a second direction opposite to the first direction and connected to the case;
a current collector plate in the case and comprising a current collector plate body portion connected to the first tab and a current collector plate liquid injection portion on the current collector plate body portion;
a cap plate sealing the case so that the electrode assembly and the current collector plate are isolated from an outside;
a rivet terminal including a rivet body portion coupled to the cap plate and a rivet liquid injection portion coupled to the current collector plate liquid injection portion; and
a sealing portion sealing the current collector plate liquid injection portion and the rivet liquid injection portion.

2. The secondary battery of claim 1, wherein the current collector plate liquid injection portion protrudes from a center of the current collector plate body portion in the first direction and comprises a current collector plate liquid injection through-hole.

3. The secondary battery of claim 2, wherein the rivet body portion comprises an upper flange portion extending horizontally outward from an upper side of the rivet liquid injection portion and on an upper side of the cap plate with an upper insulator interposed therebetween, and a lower flange portion extending horizontally outward from a lower side of the rivet liquid injection portion and located on a lower side of the cap plate with a lower insulator interposed therebetween, and
the rivet liquid injection portion is coupled through the cap plate with an insulating gasket interposed therebetween and comprises a rivet liquid injection through-hole coupled to the current collector plate liquid injection portion.

4. The secondary battery of claim 3, wherein an outer diameter surface of the current collector plate liquid injection portion and an inner diameter surface of the rivet liquid injection portion contact each other and are provided parallel to the first direction.

5. The secondary battery of claim 3, wherein an outer diameter surface of the current collector plate liquid injection portion and an inner diameter surface of the rivet liquid injection portion contact each other and are inclined with respect to the first direction.

6. The secondary battery of claim 5, wherein an outer diameter of the current collector plate liquid injection portion and an inner diameter of the rivet liquid injection portion gradually decrease as a distance from the electrode assembly increases.

7. The secondary battery of claim 1, wherein an upper side of the current collector plate liquid injection portion and an upper side of the rivet liquid injection portion are coupled by laser welding.

8. The secondary battery of claim 1, wherein the sealing portion comprises a sealing body portion covering the current collector plate liquid injection portion and the rivet liquid injection portion and a sealing protrusion coupled to the current collector plate liquid injection portion.

9. The secondary battery of claim 8, wherein the rivet liquid injection portion comprises a rivet recess on which the sealing body portion is seated.

10. The secondary battery of claim 9, wherein a circumference of the sealing body portion is coupled to the rivet recess by laser welding.

11. The secondary battery of claim 1, further comprising a sealing ball coupled to the current collector plate liquid injection portion,
wherein the sealing portion comprises a sealing body portion covering the current collector plate liquid injection portion and the rivet liquid injection portion.

12. The secondary battery of claim 11, wherein the rivet liquid injection portion comprises a rivet recess on which the sealing body portion is seated.

13. The secondary battery of claim 12, wherein a circumference of the sealing body portion is coupled to the rivet recess by laser welding.

14. The secondary battery of claim 1, wherein the case comprises a bottom portion and a side wall portion extending in the first direction from a circumference of the bottom portion, and the second tab is coupled to the bottom portion by laser welding.

15. The secondary battery of claim 14, wherein the bottom portion comprises a circumferential portion adjacent to the side wall portion, a vent notch provided in the circumferential portion, and a recessed portion extending inward from the circumferential portion and located closer to the electrode assembly than the circumferential portion.
